(19) United States
(12) Patent Application Publication
(10) Pub. No.: US 2024/0323176 A1
(43) Pub. Date: Sep. 26, 2024

(54) DYNAMIC AUTHORIZATION SYSTEM AND DYNAMIC AUTHORIZATION METHOD

(71) Applicant: Mitsubishi Electric Corporation, Tokyo (JP)

(72) Inventors: Takumi Mori, Tokyo (JP); Masahiro FUJITA, Tokyo (JP); Yoichi SHIBATA, Tokyo (JP); Tadakazu YAMANAKA, Tokyo (JP); Nori MATSUDA, Tokyo (JP)

(73) Assignee: Mitsubishi Electric Corporation, Tokyo (JP)

(21) Appl. No.: 18/735,754

(22) Filed: Jun. 6, 2024

Related U.S. Application Data
(63) Continuation of application No. PCT/JP2022/003776, filed on Feb. 1, 2022.

(51) Int. Cl. H04L 9/40

(52) U.S. Cl. CPC H04L 63/0807; H04L 63/12

(57) ABSTRACT

A client terminal (200) acquires a ticket (110) including a scope indicating an authorization condition, collects a context to indicate a state of the client terminal, sets the context in the ticket, and transmits the ticket. The authorization server (400) receives the ticket, determines a condition element other than the context among one or more condition elements indicated in the authorization condition as reinforcement information (111), requests the reinforcement information determined to a context reinforcement device (500), receives the reinforcement information, and verifies the scope based on the context and the reinforcement information.

### CROSS REFERENCE TO RELATED APPLICATIONS

This application is a Continuation of PCT International Application No. PCT/JP2022/003776, filed on Feb. 1, 2022, which is hereby expressly incorporated by reference into the present application.

### TECHNICAL FIELD

The present disclosure relates to a technique for dynamic authorization.

### BACKGROUND ART

Conventionally, company secrets have been strictly protected within companies.

However, due to the increase of remote work and use of cloud computing, company secrets have been accessed from the inside or outside of the company, or from the inside or outside of the country irrespective of daytime and nighttime.

Therefore, IT systems that can be handled without limitation of the time, place and devices have been sought.

IT is an abbreviation for Information Technology.

It is difficult to deal with access irrespective of time and location with a measure of protecting borders by fixed access rules.

Thus, a concept called “Zero Trust” has appeared. Zero Trust is not a model in which a trusted network is protected by security measures. Zero Trust is a model in which trust is obtained depending on the situation by various security functions, and no one is trusted.

Zero Trust is defined in NIST SP800-207, and realized by a scheme of authorization based on context information. As concrete examples of the scheme of authorization, there are OAuth and SAML.

For example, reliability of a user is verified by authenticating a device used by the user instead of a user ID and a password.

Further, Patent Literature 1 discloses a method to verify a scope by using information registered beforehand by a service provider. Scope is a combination of a user and a service.

As described above, techniques to perform authentication and authorization for users using various information have been developed.

### CITATION LIST

### Patent Literature

Patent Literature 1: JP2020/119342 A

### SUMMARY OF INVENTION

### Technical Problem

It is necessary to reinforce reliability of context information when the context information is presented by a client, and authorization using the context information is performed.

This disclosure is aimed at making it possible to reinforce reliability of the context information, and perform authorization.

### Solution to Problem

A dynamic authorization system according to the present disclosure includes a client terminal, an authorization server and a context reinforcement device, wherein
the client terminal acquires a ticket including a scope to indicate an authorization condition, collects a context to indicate a state of the client terminal, sets the context in the ticket, and transmits the ticket,
the authorization server receives the ticket, determines a condition element other than the context among one or more condition elements indicated in the authorization condition as reinforcement information, and requests the reinforcement information determined to the context reinforcement device,
the context reinforcement device transmits the reinforcement information requested to the authorization server, and
the authorization server receives the reinforcement information, and verifies the scope based on the context and the reinforcement information.

### Advantageous Effects of Invention

According to the present disclosure, a scope (authorization condition) is verified based on reinforcement information in addition to context. That is, it is possible to reinforce reliability of context information, and perform authorization.

### BRIEF DESCRIPTION OF DRAWINGS

FIG. 1 is a configuration diagram of a dynamic authorization system 100 according to a first embodiment;

FIG. 2 is a configuration diagram of a client terminal 200 according to the first embodiment;

FIG. 3 is a configuration diagram of a resource server 300 according to the first embodiment;

FIG. 4 is a configuration diagram of an authorization server 400 according to the first embodiment;

FIG. 5 is a configuration diagram of a context reinforcement device 500 according to the first embodiment;

FIG. 6 is a flowchart of a dynamic authorization method according to the first embodiment;

FIG. 7 is a flowchart of Step S1 according to the first embodiment;

FIG. 8 is a flowchart of Step S12 according to the first embodiment;

FIG. 9 is a flowchart of Step S2 according to the first embodiment;

FIG. 10 is a flowchart of Step S3 according to the first embodiment;

FIG. 11 is a flowchart of Step S3 according to the first embodiment;

FIG. 12 is a flowchart of Step S35 according to the first embodiment;

FIG. 13 is a flowchart of Step S354 according to the first embodiment;

FIG. 14 is a diagram illustrating an example of a ticket 110 according to the first embodiment;

FIG. 15 is a configuration diagram of the dynamic authorization system 100 according to a second embodiment;

FIG. 16 is a configuration diagram of the client terminal 200 according to the second embodiment;

FIG. 17 is a flowchart of storing reinforcement information according to the second embodiment;

FIG. 18 is a configuration diagram of the dynamic authorization system 100 according to a third embodiment;

FIG. 19 is a configuration diagram of a repeater 600 according to the third embodiment;

FIG. 20 is a configuration diagram of a context reinforcement device 500 according to the third embodiment;

FIG. 21 is a flowchart of certificate acquisition according to the third embodiment;

FIG. 22 is a flowchart of Step S12C according to the third embodiment;

FIG. 23 is a flowchart of Step S21 according to the third embodiment;

FIG. 24 is a flowchart of Step S22 according to the third embodiment;

FIG. 25 is a configuration diagram of the dynamic authorization system 100 according to a fourth embodiment;

FIG. 26 is a configuration diagram of the dynamic authorization system according to a fifth embodiment;

FIG. 27 is a configuration diagram of an intranet system 130 according to the fifth embodiment;

FIG. 28 is a configuration diagram of a gate device 700 according to the fifth embodiment;

FIG. 29 is a flowchart of Step S2 according to the fifth embodiment;

FIG. 30 is a flowchart of Step S24E according to the fifth embodiment;

FIG. 31 is a diagram of a hardware configuration of the client terminal 200 according to embodiments;

FIG. 32 is a diagram of a hardware configuration of the resource server 300 according to the embodiments;

FIG. 33 is a diagram of a hardware configuration of the authorization server 400 according to the embodiments;

FIG. 34 is a diagram of a hardware configuration of the context reinforcement device 500 according to the embodiments;

FIG. 35 is a diagram of a hardware configuration of the repeater 600 according to the embodiments, and

FIG. 36 is a diagram of a hardware configuration of the gate device 700 according to the embodiments.

### DESCRIPTION OF EMBODIMENTS

In the description and diagrams of embodiments, same elements or corresponding elements are denoted by same reference numerals. Description of elements denoted by the same reference numerals as elements described is appropriately omitted or simplified. Arrows in the diagrams mainly represent flows of data or processing.

### First Embodiment

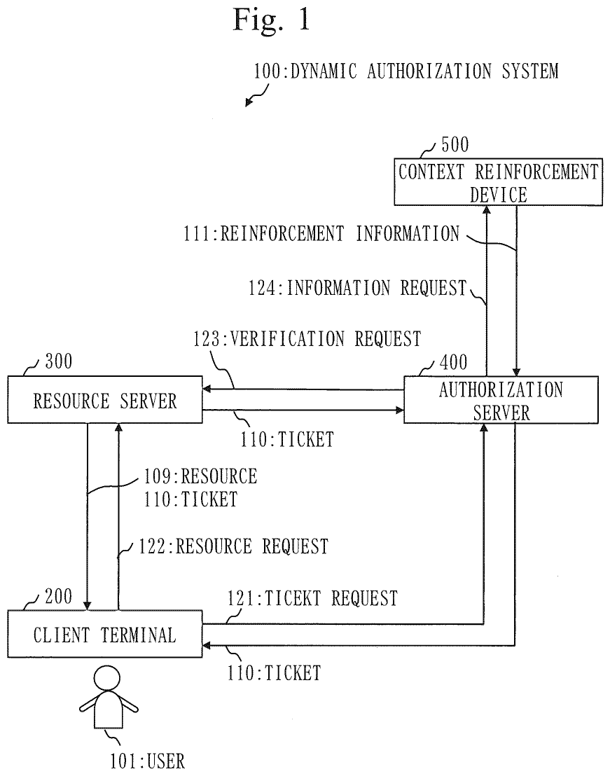

Description will be made on a dynamic authorization system 100 based on FIG. 1 through FIG. 14.

### Description of Configuration

Description will be made on a configuration of the dynamic authorization system 100 based on FIG. 1.

The dynamic authorization system 100 is a system to dynamically authorize use of resources.

The dynamic authorization system 100 includes one or more client terminals 200.

The dynamic authorization system 100 includes a resource server 300, an authorization server 400 and a context reinforcement device 500.

The client terminal may be called a client or a client device.

The server may be called a server device.

A user 101 is a user of the client terminal 200. The user 101 may be called a client.

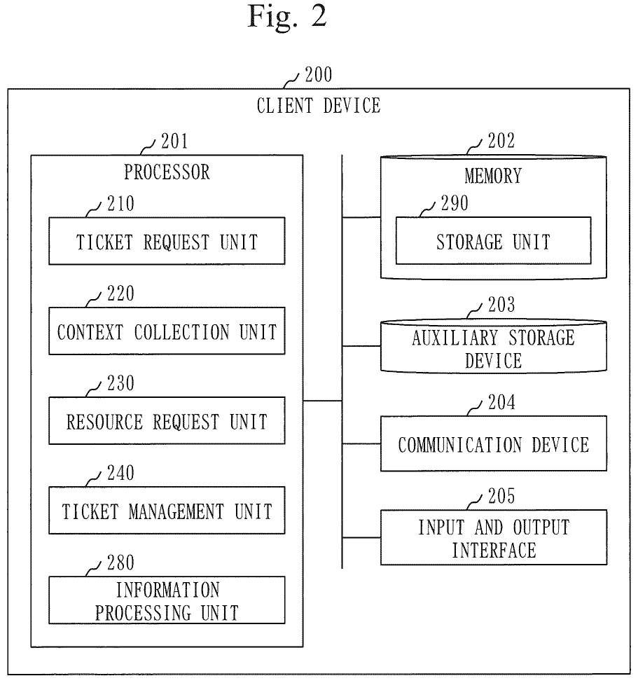

Description will be made on a configuration of the client terminal 200 based on FIG. 2.

The client terminal 200 is a computer including hardware components such as a processor 201, a memory 202, an auxiliary storage device 203, a communication device 204, an input and output interface 205 and the like. These hardware components are connected with one another via signal lines.

The processor 201 is an IC to perform arithmetic processing, and controls other hardware components. For example, the processor 201 is a CPU.
IC is an abbreviation for Integrated Circuit.
CPU is an abbreviation for Central Processing Unit.

The memory 202 is a volatile or non-volatile storage device. The memory 202 is also referred to as a main storage device or a main memory. For example, the memory 202 is a RAM. The data stored in the memory 202 is stored in the auxiliary storage device 203 as needed.
RAM is an abbreviation for Random Access Memory.

The auxiliary storage device 203 is a non-volatile storage device. For example, the auxiliary storage device 203 is a ROM, an HDD, a flash memory, or a combination thereof. The data stored in the auxiliary storage device 203 is loaded into the memory 202 as needed.
ROM is an abbreviation for Read Only Memory.
HDD is an abbreviation for Hard Disk Drive.

The communication device 204 is a receiver and a transmitter. For example, the communication device 204 is a communication chip or an NIC. The communication by the client terminal 200 is performed using the communication device 204.
NIC is an abbreviation for Network Interface Card.

The input and output interface 205 is a port to which an input device and an output device are connected. For example, the input and output interface 205 is a USB terminal, the input device is a keyboard and a mouse, and the output device is a display. The input and output to and from the client terminal 200 are performed by using the input and output interface 205.
USB is an abbreviation for Universal Serial Bus.

The client terminal 200 includes elements such as a ticket request unit 210, a context collection unit 220, a resource request unit 230, a ticket management unit 240 and an information processing unit 280. These elements are realized by software.

The auxiliary storage device 203 stores a client terminal program to make a computer function as the ticket request unit 210, the context collection unit 220, the resource request unit 230, the ticket management unit 240 and the information processing unit 280. The client terminal program is loaded into the memory 202, and executed by the processor 201.

The auxiliary storage device 203 further stores an OS. At least a part of the OS is loaded into the memory 202, and executed by the processor 201.

The processor 201 executes the client terminal program while executing the OS. OS is an abbreviation for Operating System.

The input and output data of the client terminal program is stored in the storage unit 290.

The memory 202 functions as a storage unit 290. However, storage devices such as the auxiliary storage device 203, a register in the processor 201, a cache memory in the processor 201 and the like may function as the storage unit 290 instead of the memory 202, or along with the memory 202.

The client terminal 200 may include a plurality of processors to be substitutes for the processor 201.

It is possible for a program to be recorded (stored) in a non-volatile recording medium such as an optical disk, a flash memory or the like in a computer-readable manner.

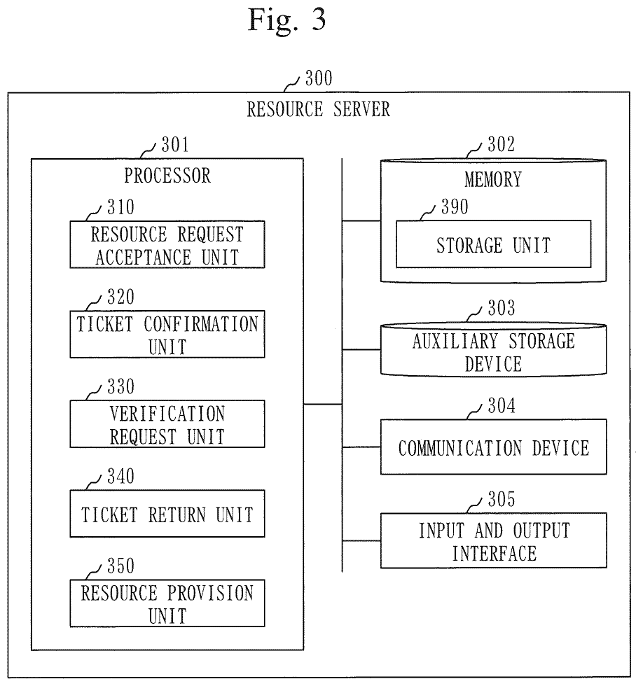

Description will be made on a configuration of the resource server 300 based on FIG. 3.

The resource server 300 is a computer including hardware components such as a processor 301, a memory 302, an auxiliary storage device 303, a communication device 304 and an input and output interface 305. These hardware components are connected with one another via signal lines.

The processor 301 is an IC to perform arithmetic processing, and controls other hardware components. For example, the processor 301 is a CPU.

The memory 302 is a volatile or non-volatile storage device. The memory 302 is also called a main storage device or a main memory. For example, the memory 302 is a RAM. The data stored in the memory 302 is stored in the auxiliary storage device 303 as needed.

The auxiliary storage device 303 is a non-volatile storage device. For example, the auxiliary storage device 303 is a ROM, an HDD, a flash memory or a combination thereof. The data stored in the auxiliary storage device 303 is loaded into the memory 302 as needed.

The communication device 304 is a receiver and a transmitter. For example, the communication device 304 is a communication chip or an NIC. Communication by the resource server 300 is performed using the communication device 304.

The input and output interface 305 is a port to which an input device and an output device are connected. For example, the input and output interface 305 is a USB terminal, the input device is a keyboard and a mouse, and the output device is a display.

The input and output to and from the resource server 300 are performed by using the input and output interface 305.

The resource server 300 includes elements such as a resource request acceptance unit 310, a ticket confirmation unit 320, a verification request unit 330, a ticket return unit 340 and a resource provision unit 350. These elements are realized by software.

The auxiliary storage device 303 stores a resource server program to cause a computer to function as the resource request acceptance unit 310, the ticket confirmation unit 320, the verification request unit 330, the ticket return unit 340 and the resource provision unit 350. The resource program is loaded into the memory 302, and executed by the processor 301.

The auxiliary storage device 303 further stores an OS. At least a part of the OS is loaded into the memory 302, and executed by the processor 301.

The processor 301 executes the resource server program while executing the OS.

The input and output data of the resource server program is stored in the storage unit 390.

The memory 302 functions as a storage unit 390. However, storage devices such as the auxiliary storage device 303, a register in the processor 301, a cache memory in the processor 301 and the like may function as the storage unit 390 instead of the memory 302, or along with the memory 302.

The resource server 300 may include a plurality of processors to be substitutes for the processor 301.

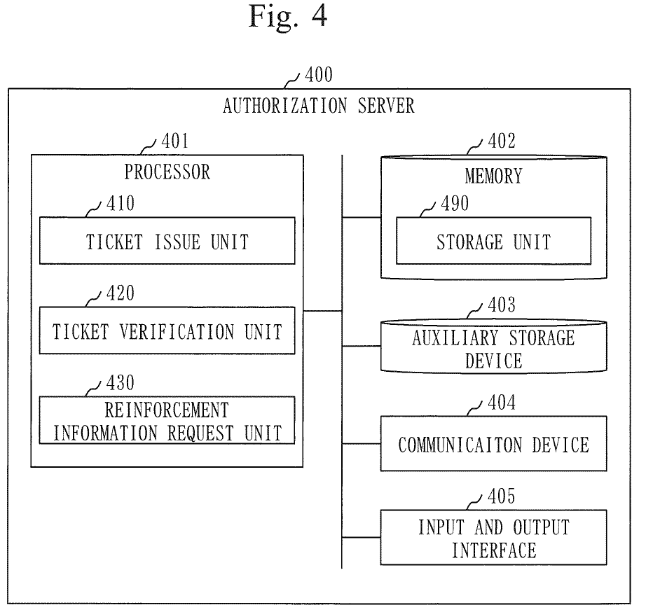

Description will be made on a configuration of an authorization server 400 based on FIG. 4.

The authorization server 400 is a computer including hardware components such as a processor 401, a memory 402, an auxiliary storage device 403, a communication device 404, an input and output interface 405 and the like. These hardware components are connected with one another via signal lines.

The processor 401 is an IC to perform arithmetic processing, and controls other hardware components. For example, the processor 401 is a CPU.

The memory 402 is a volatile or non-volatile storage device. The memory 402 is also called a main storage device or a main memory. For example, the memory 402 is a RAM. The data stored in the memory 402 is stored in the auxiliary storage device 403 as needed.

The auxiliary storage device 403 is a non-volatile storage device. For example, the auxiliary storage device 403 is a ROM, an HDD, a flash memory or a combination thereof. The data stored in the auxiliary storage device 403 is loaded into the memory 402 as needed.

The communication device 404 is a receiver and a transmitter. For example, the communication device 404 is a communication chip or an NIC. The communication by the authorization server 400 is performed using the communication device 404.

The input and output interface 405 is a port to which an input device and an output device are connected. For example, the input and output interface 405 is a USB terminal, the input device is a keyboard and a mouse, and the output device is a display.

The input and output to and from the authorization server 400 are performed by using the input and output interface 405.

The authorization server 400 includes elements such as a ticket issue unit 410, a ticket verification unit 420 and a reinforcement information request unit 430. These elements are realized by software.

The auxiliary storage device 403 stores an authorization server program to cause a computer to function as the ticket issue unit 410, the ticket verification unit 420 and the reinforcement information request unit 430. The authorization server program is loaded into the memory 402, and executed by the processor 401.

The auxiliary storage device 403 further stores an OS. At least a part of the OS is loaded into the memory 402, and executed by the processor 401.

The processor 401 executes the authorization server program while executing the OS.

The input and output data of the authorization server program is stored in a storage unit 490.

The memory 402 functions as the storage unit 490. However, storage devices such as the auxiliary storage device 403, a register in the processor 401, a cache memory in the processor 401 and the like may function as the storage unit 490 instead of the memory 402, or along with the memory 402.

The authorization server 400 may include a plurality of processors to be substitutes for the processor 401.

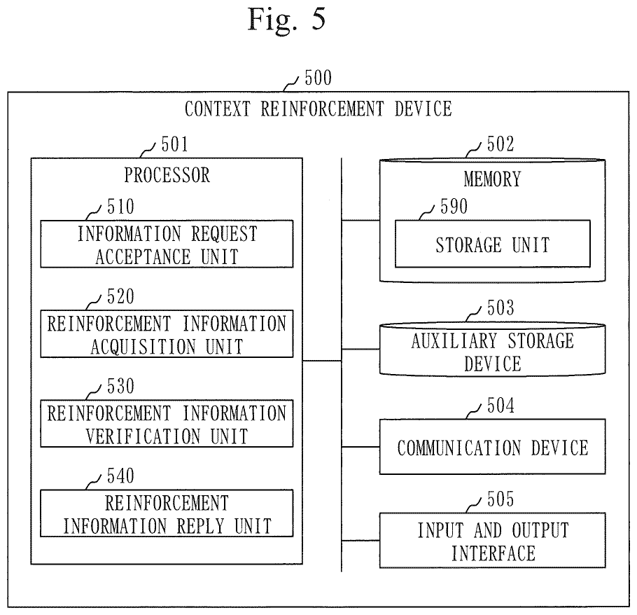

Description will be made on a configuration of a context reinforcement device 500 based on FIG. 5.

The context reinforcement device 500 is a computer including hardware components such as a processor 501, a memory 502, an auxiliary storage device 503, a communication device 504, an input and output interface 505 and the like. These hardware components are connected with one another via signal lines.

The processor 501 is an IC to perform arithmetic processing, and controls other hardware components. For example, the processor 501 is a CPU.

The memory 502 is a volatile or non-volatile storage device. The memory 502 is also called a main storage device or a main memory. For example, the memory 502 is a RAM. The data stored in the memory 502 is stored in the auxiliary storage device 503 as needed.

The auxiliary storage device 503 is a non-volatile storage device. For example, the auxiliary storage device 503 is a ROM, an HDD, a flash memory or a combination thereof. The data stored in the auxiliary storage device 503 is loaded into the memory 502 as needed.

The communication device 504 is a receiver and a transmitter. For example, the communication device 504 is a communication chip or an NIC. Communication by the context reinforcement device 500 is performed using the communication device 504.

The input and output interface 505 is a port to which an input device and an output device are connected. For example, the input and output interface 505 is a USB terminal, the input device is a keyboard and a mouse, and the output device is a display. The input and output to and from the context reinforcement device 500 are performed by using the input and output interface 505.

The context reinforcement device 500 includes elements such as an information request acceptance unit 510, a reinforcement information acquisition unit 520, a reinforcement information verification unit 530 and a reinforcement information reply unit 540. These elements are realized by software.

The auxiliary storage device 503 stores a context reinforcement program to cause a computer to function as the information request acceptance unit 510, the reinforcement information acquisition unit 520, the reinforcement information verification unit 530 and the reinforcement information reply unit 540. The context reinforcement program is loaded into the memory 502, and executed by the processor 501.

The auxiliary storage device 503 further stores an OS. At least a part of the OS is loaded into the memory 502, and executed by the processor 501.

The processor 501 executes the context reinforcement program while executing the OS.

The input and output data of the context reinforcement program is stored in a storage unit 590.

The memory 502 functions as a storage unit 590. However, storage devices such as the auxiliary storage device 503, a register in the processor 501, a cache memory in the processor 501 and the like may function as the storage unit 590 instead of the memory 502, or along with the memory 502.

The context reinforcement device 500 may include a plurality of processors to be substitutes for the processor 501.

### Description of Operation

A procedure of the operation of the dynamic authorization system 100 corresponds to a dynamic authorization method. Further, the procedure of the operation of the dynamic authorization system 100 corresponds to a procedure of processing by a dynamic authorization program. The dynamic authorization program includes the client terminal program, the resource server program, the authorization server program and the context reinforcement program.

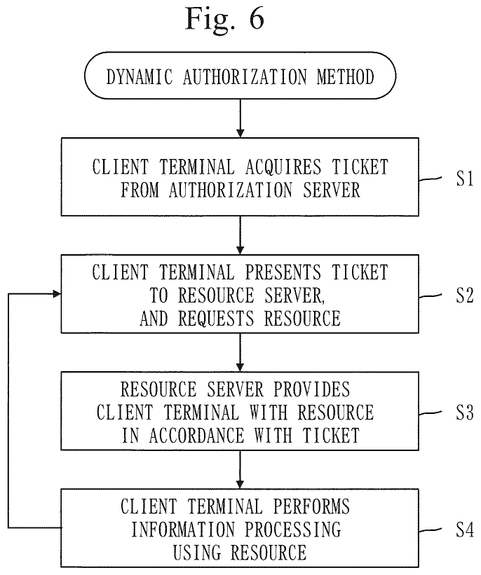

Description will be made on a dynamic authorization method based on FIG. 6.

In Step S1, the client terminal 200 acquires a ticket 110 from the authorization server 400.

The ticket 110 is data used for deciding authorization.

Details of Step S1 will be described later.

In Step S2, the client terminal 200 presents the ticket 110 to the resource server 300, and requests a resource 109 to the resource server 300.

Details of Step S2 will be described later.

In Step S3, the resource server 300 provides the client terminal 200 with the resource 109 depending on the ticket 110.

Details of Step S3 will be described later.

In Step S4, the client terminal 200 performs information processing using the resource 109.

Specifically, the information processing unit 280 performs the information processing. The information processing is performed as follows.

First, the information processing unit 280 starts execution of the information processing program. The information processing program is stored in the storage unit 290 in advance.

When the resource 109 becomes necessary during execution of the information processing program, Step S2 and Step S3 are performed.

Then, the information processing unit 280 continues execution of the information processing program using the resource 109.

After Step S4, the processing proceeds to Step S2.

Step S2 through Step S4 are continued until the information processing is completed.

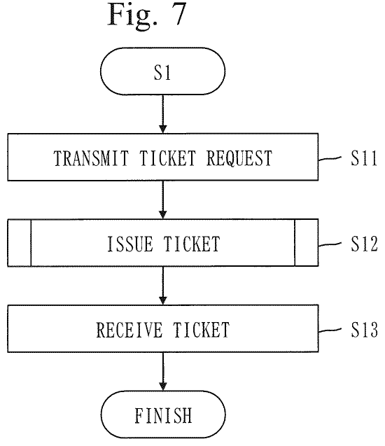

Description will be made on the procedure of Step S1 based on FIG. 7.

In Step S11, the ticket request unit 210 generates a ticket request 121, and transmits the ticket request 121 to the authorization server 400.

The ticket request 121 is data to request the ticket 110.

The ticket request 121 includes user information.

The user information is information to identify the user 101. Concrete examples of the user information are a user identifier and a password.

In Step S12, the authorization server 400 issues the ticket 110.

Details of Step S12 will be described below.

In Step S13, the ticket request unit 210 receives the ticket 110 from the authorization server 400.

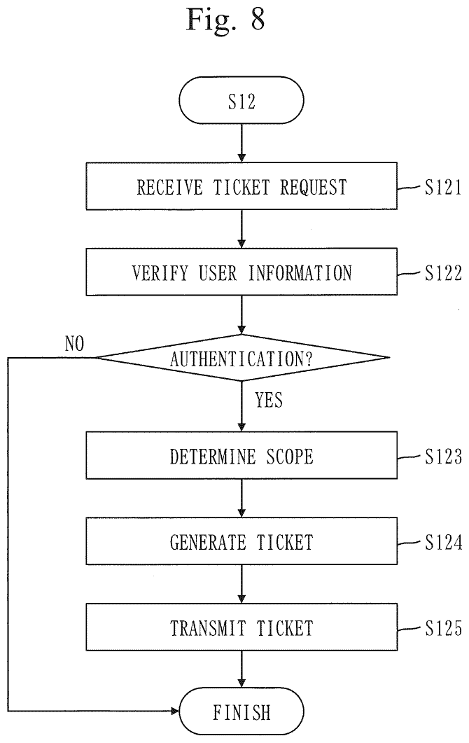

Description will be made on a procedure of Step S12 based on FIG. 8.

In Step S121, the ticket issue unit 410 receives the ticket request 121.

In Step S122, the ticket issue unit 410 extracts the user information from the ticket request 121. The user information extracted is called target information.

Then, the ticket issue unit 410 verifies the target information.

The target information is verified as follows.

User registration data is stored in the storage unit 490 in advance.

The user registration data is data in which each piece of user information of one or more legitimate users is registered.

The ticket issue unit 410 decides whether user information identical with the target information is registered in the user registration data.

When user information identical with the target information is registered, the ticket issue unit 410 authenticates the target information.

When user information identical with the target information is not registered, the ticket issue unit 410 does not authenticate the target information.

Verification of the target information may be performed by using a device for user authentication such as a directory server or an authentication server.

When the user information (target information) is authenticated, the process proceeds to Step S123.

When the user information is not authenticated, the process is finished. In this case, the ticket 110 is not provided to the client terminal 200 from the authorization server 400, and the client terminal 200 is incapable of performing the information processing using the resource 109. That is, Step S2 through Step S4 are not performed.

In Step S123, the ticket issue unit 410 determines a scope based on the user information.

The scope represents an authorization condition for the resource 109.

The authorization condition is a condition for authorizing use of the resource 109.

The scope is determined as follows.

Scope management data is stored in the storage unit 490 beforehand.

The scope management data indicates a scope by associating the scope with each of one or more user identifiers. The scope management data corresponds to an access control list (ACL).

The ticket issue unit 410 extracts a scope associated with the same user identifier as the user identifier indicated in the user information from the scope management data. The scope extracted shall be a scope to be determined.

In Step S124, the ticket issue unit 410 generates a ticket 110.

The ticket 110 includes a user identifier, a scope, a context, reinforcement information 111, a validity period and a state identifier.

The context will be described later. In Step S124, the context is not set in the ticket 110.

The reinforcement information 111 will be described later. In Step S124, the reinforcement information 111 is not set in the ticket 110.

The validity period specifies a period during which the ticket 110 is valid. In Step S124, the validity period is not set in the ticket 110.

The state identifier indicates a state of the ticket 110. In Step S124, the state of the ticket 110 is invalid.

In Step S125, the ticket issue unit 410 transmits the ticket 110 to the client terminal 200.

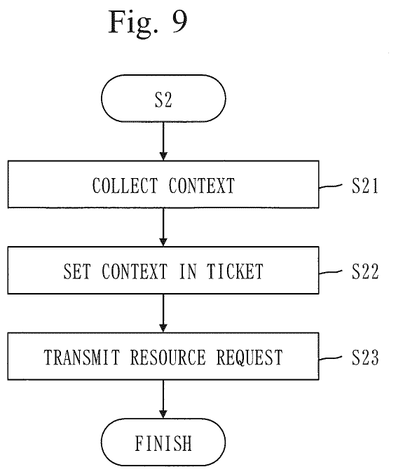

The procedure of Step S2 will be described based on FIG. 9.

In Step S21, the context collection unit 220 collects a context.

The context is information to indicate a state of the client terminal 200.

A concrete example of the context is manufacturing information, access point information, encryption information, environment information, position information and the like.

The manufacturing information is information related to manufacturing of the client terminal 200. For example, the manufacturing information is a serial number or a manufacturer identifier.

The access point information is information to specify an access point used by the client terminal 200. For example, the access point information is an SSID. SSID is an abbreviation for Service Set Identifier.

The encryption information is information to specify an encryption scheme used for communication of the client terminal 200.

The environment information is information to specify an execution environment of the client terminal 200. For example, the environment information indicates an OS.

The position information is information to indicate a position of the client terminal 200. For example, the client terminal 200 includes a satellite positioning system, and the satellite positioning system obtains the coordinate value of the client terminal 200. A concrete example of the satellite positioning system is GPS. GPS is an abbreviation for Global Positioning System.

In Step S22, the resource request unit 230 sets the context collected in the ticket 110.

However, if a context has already been set in the ticket 110, the context that has been set is overwritten with the context collected.

In Step S23, the resource request unit 230 generates a resource request 122, and transmits the resource request 122 to the resource server 300.

The resource request 122 is data to request a resource 109.

The resource request 122 includes resource information and a ticket 110.

The resource information identifies the resource 109 to be requested.

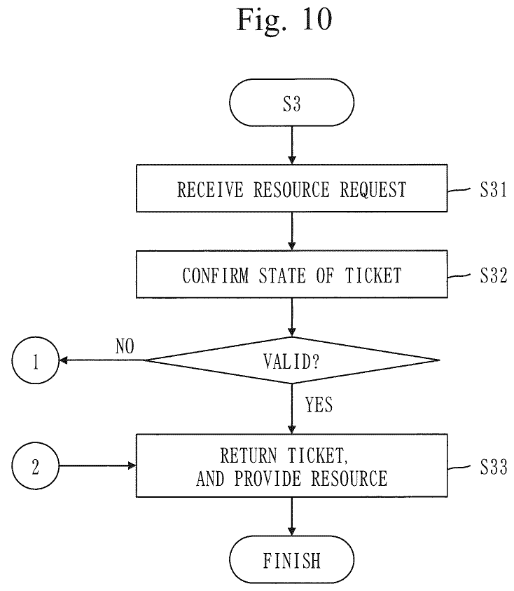

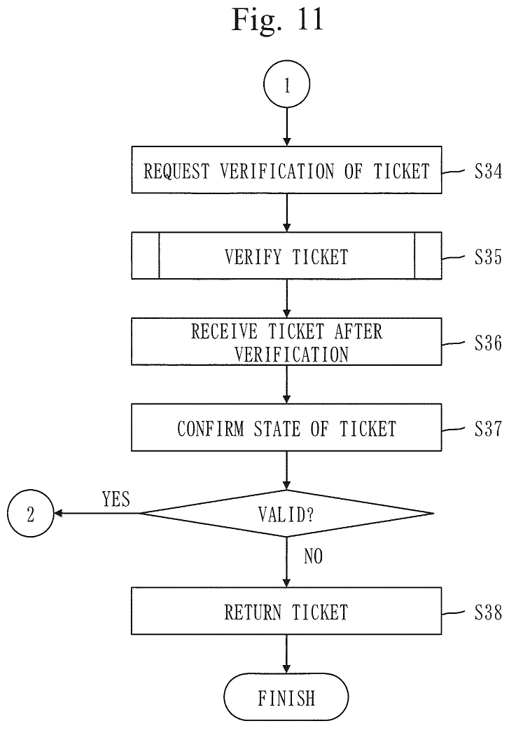

The procedure of Step S3 will be described based on FIG. 10 and FIG. 11.

In Step S31, the resource request acceptance unit 310 receives the resource request 122.

In Step S32, the ticket confirmation unit 320 extracts the ticket 110 from the resource request 112, and confirms the state of the ticket 110.

Specifically, the ticket confirmation unit 320 refers to the state identifier indicated in the ticket 110, and the validity period indicated in the ticket 110.

When the state identifier indicates “valid”, and the validity period has not passed, the state of the ticket 110 is valid.

When the state of the ticket 110 is valid, the process proceeds to Step S33.

When the state of the ticket 110 is invalid, the process proceeds to Step S34.

In Step S33, the ticket return unit 340 returns the ticket 110 to the client terminal 200.

Further, the resource provision unit 350 provides the client terminal 200 with the resource 109 requested.

After Step S33, Step S3 is finished.

In Step S34, the verification request unit 330 generates a verification request, and transmits the verification request to the authorization server 400.

The verification request is data to request verification of a ticket 110.

The verification request includes the ticket 110.

In Step S35, the authorization server 400 verifies the ticket 110.

Details of Step S35 will be described later.

In Step S36, the verification request unit 330 receives the ticket 110 after verification from the resource server 300.

The ticket confirmation unit 320 confirms the state of the ticket 110 after verification.

Specifically, the ticket confirmation unit 320 refers to the state identifier indicated in the ticket 110 after verification.

When the state of the ticket 110 is valid, the process proceeds to Step S33.

When the state of the ticket 110 is invalid, the process proceeds to Step S38.

In Step S38, the ticket return unit 340 returns the ticket 110 after verification to the client terminal 200.

In this case, the resource 109 requested is not provided to the client terminal 200, and the client terminal 200 is incapable of performing information processing using the resource 109. That is, Step S4 is not performed.

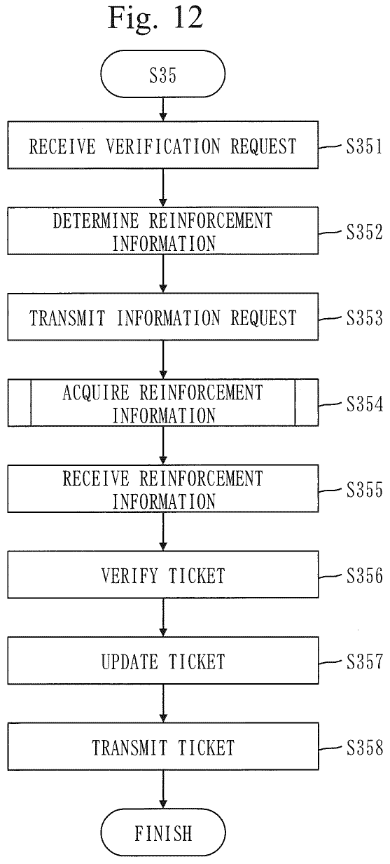

The procedure of Step S35 will be described based on FIG. 12.

In Step S351, the ticket verification unit 420 receives the verification request form the resource server 300.

In Step S352, the ticket verification unit 420 extracts the ticket 110 from the verification request, and extracts the scope from the ticket 110.

Then, the ticket verification unit 420 determines reinforcement information 111 based on the scope.

The scope indicates an authorization condition.

The authorization condition is defined using one or more condition elements.

The reinforcement information 111 is an element other than the context among one or more condition elements indicated in the authorization condition.

The reinforcement information 111 is determined as follows.

First, the ticket verification unit 420 extracts the context from the ticket 110.

Then, the ticket verification unit 420 excludes a condition element corresponding to the context extracted, from the condition elements of the authorization condition. The remaining condition elements are the reinforcement information 111 to be determined.

In Step S353, the reinforcement information request unit 430 generates an information request, and transmits the information request to the context reinforcement device 500.

The information request is data to request the reinforcement information 111.

The information request includes a user identifier and an information list.

The information list indicates types of the reinforcement information 111.

In Step S354, the context reinforcement device 500 acquires the reinforcement information 111.

Details of Step S354 will be described later.

In Step S355, the reinforcement information request unit 430 receives the reinforcement information 111 from the context reinforcement device 500.

In Step S356, the ticket verification unit 420 verifies the ticket 110.

Specifically, the ticket verification unit 420 verifies the scope based on the context and the reinforcement information 111. That is, the ticket verification unit 420 decides whether the context and the reinforcement information 111 meet the authorization condition.

In Step S357, the ticket verification unit 420 reflects the verification result on the ticket 110, and updates the ticket 110.

The ticket 110 is updated as follows.

The ticket verification unit 420 sets the reinforcement information 111 received in the ticket 110. However, when reinforcement information 111 has been set in the ticket 110, the reinforcement information 111 that has been set is updated with the reinforcement information 111 received.

When the authorization condition is met, the ticket verification unit 420 updates the state identifier set in the ticket 110 to a state identifier indicating validity. That is, the ticket verification unit 420 changes the state of the ticket 110 to valid.

When the authorization condition is met, the ticket verification unit 420 determines a validity period, and sets the validity period in the ticket 110. However, when a validity period has been set in the ticket 110, the validity period that has been set is updated to the validity period determined.

The validity period is determined as follows. Period management data is stored in the storage unit 490 beforehand. The period management data indicates a validity period for each type of contexts. The ticket verification unit 420 selects a validity period corresponding to the context set in the ticket 110 from the period management data. When a plurality of types of contexts are set in the ticket 110, the ticket verification unit 420 selects a shortest validity period from among the validity periods corresponding to the plurality of types of contexts. Then, the ticket verification unit 420 determines the validity period based on a current time and the validity period selected.

When the authorization condition is not met, the ticket verification unit 420 updates the state identifier set in the ticket 110 to a state identifier indicating “invalid”. That is, the ticket verification unit 420 changes the state of the ticket 110 to invalid.

In Step S358, the ticket verification unit 420 transmits the ticket 110 to the authorization server 400.

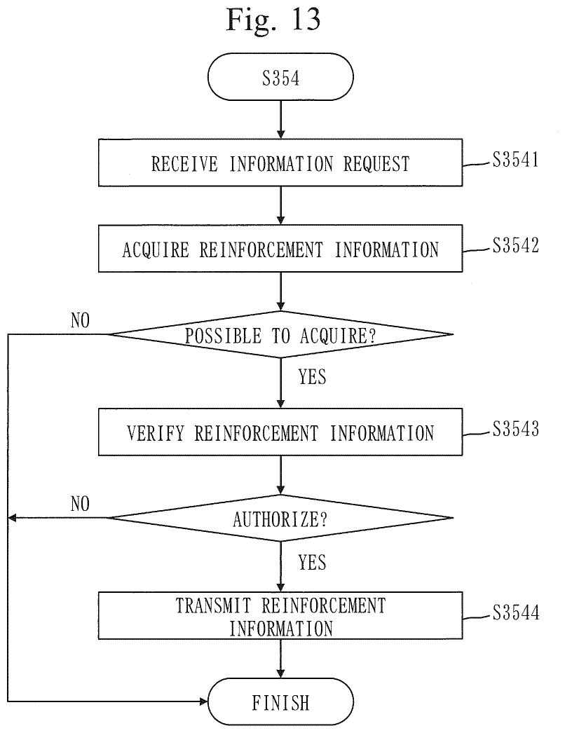

The procedure of Step S354 will be described based on FIG. 13.

In Step S3541, the information request acceptance unit 510 receives an information request from the authorization server 400.

In Step S3542, the reinforcement information acquisition unit 520 acquires reinforcement information 111 of the type indicated in the information request.

The reinforcement information 111 is acquired as follows.

Each type of reinforcement information 111 is associated with each user identifier, and stored in the storage unit 590. The reinforcement information acquisition unit 520 extracts the reinforcement information 111 of the type indicated in the information request from among the reinforcement information 111 associated with the same user identifier as the user identifier indicated in the information request.

Each piece of reinforcement information 111 is acquired from an external device, and stored. The external device is a device other than the context reinforcement device 500, and manages the reinforcement information 111 corresponding to each user identifier. Each piece of the reinforcement information 111 can be acquired actively or passively from the external device using an API. API is an abbreviation for Application Programming Interface.

When it is possible to acquire the reinforcement information 111, the process proceeds to Step S3543.

When it is impossible to acquire the reinforcement information 111, the process is finished. In this case, the reinforcement information 111 is not provided to the authorization server 400 from the context reinforcement device 500, and the ticket 110 is returned to the resource server 300 from the authorization server 400 without being updated to a valid state.

In Step S3543, the reinforcement information verification unit 530 verifies the reinforcement information 111 as needed. That is, the reinforcement information verification unit 530 verifies the reinforcement information 111 when it is possible to verify the reinforcement information 111.

When an electronic signature is attached to the reinforcement information 111, the reinforcement information 111 is verified as follows.

An electronic certificate of the external device is stored in the storage unit 590 beforehand. The electronic signature is generated using a signing key. The electronic certificate includes a verification key corresponding to the signing key. The reinforcement information verification unit 530 verifies the electronic signature attached to the reinforcement information 111 using the verification key included in the electronic signature. When the electronic signature is valid, the reinforcement information 111 is authenticated.

When the reinforcement information 111 is authenticated, or authentication of the reinforcement information 111 is unnecessary, the process proceeds to Step S3544.

When the reinforcement information 111 is not authenticated, the process is finished. In this case, the reinforcement information 111 is not provided to the authorization server 400 from the context reinforcement device 500, and the ticket 110 is returned to the resource server 300 from the authorization server 400 without being updated to a valid state.

In Step S3544, the reinforcement information reply unit 540 transmits the reinforcement information 111 to the authorization server 400.

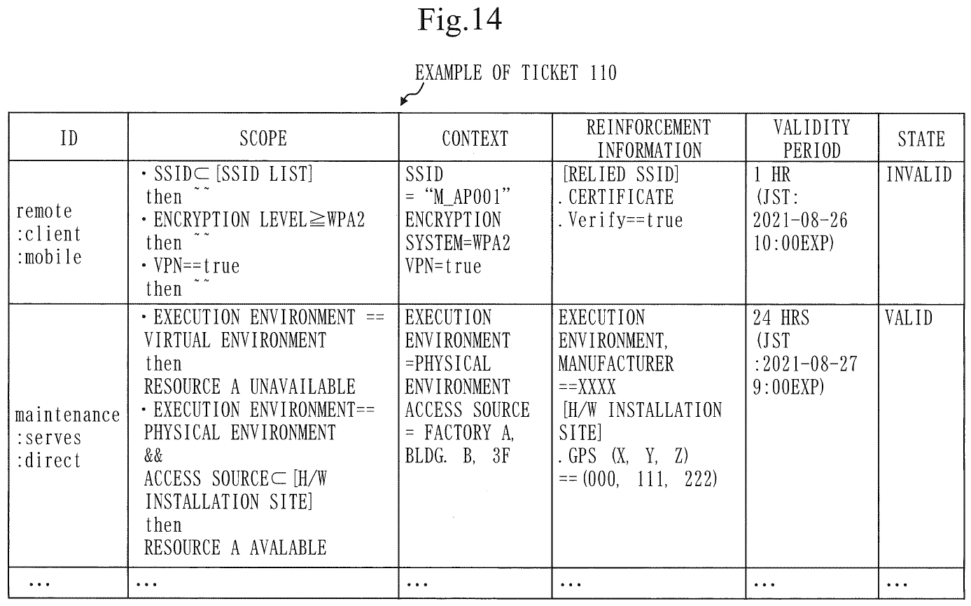

The ticket 110 will be described based on FIG. 14. FIG. 14 illustrates an example of two tickets 110.

The ticket 110 includes a user identifier, a scope, a context, reinforcement information 111, a validity period and a state identifier.

In the scope, each of “SSID”, “encryption level”, “VPN”, “execution environment” and “access source” is a condition element. For example, the scope indicates whether it is possible to use a resource A depending on the conditions. A concrete example of the resource A is an external CD drive.

A concrete example of the context is information such as “SSID”, “encryption scheme”, “execution environment” and “access source”.

A concrete example of the reinforcement information is information such as “verified electronic certificate”, “manufacturer” and “H/W installation site”. H/W means hardware.

### Overview of First Embodiment

An overview of Frist Embodiment will be described below.

When a client accesses information in a resource server, context information (attribute group) necessary for authorization of the client is presented to the authorization server. The authorization server obtains information from another information source in order to reinforce attribute information that has been presented but yet to be fully relied on. Then, the authorization server performs verification using the information obtained from the other information source.

The authorization process by the authorization server is performed each time the resource server is accessed. Therefore, it is possible to add information to an authentication ticket. Then, the context information at that point of time is accumulated in the authentication ticket.

An authentication condition (scope) is described in the authentication ticket. Then, the context is evaluated at a point of time when the context is redirected to the authorization server during user authentication.

The context from the client is recorded as present context information.

The context from the information source (except the client) is added and accumulated as latest reinforcement information.

A validity period is set in the authentication ticket. The validity period is determined based on a guarantee standard of reliability for each attribute of an evaluation target. Specifically, the validity period is determined in accordance with decrease in reliability due to the time elapsed.

### Feature of First Embodiment

The feature of First Embodiment will be described below.” The symbols in parentheses are symbols of corresponding elements.

The dynamic authorization system (100) includes a reinforcement information acquisition/verification instrument (500) to handle the reinforcement information (111). The reinforcement information reinforces context information presented from a client (200) for authentication or authorization.

### Effect of First Embodiment

In First Embodiment, information to reinforce context information (used OS, secure boot state, access point and so on) obtained from the client is acquired from another information source and used. In this manner, reliability of authentication and authorization is improved.

By the validity period being set, the context information that changes in accordance with the time elapsed can be used for authorization. That is, the reliability value of the context information is changed in accordance with the time elapsed for authentication and authorization. If necessary, reverification is performed.

The reliability of authentication and authorization can be ensured even when a false context is presented from a client. That is, it is possible to prevent a fraud by a person inside an organization.

The accuracy of a context existing between the client and a server is guaranteed, and the context can be used for the authorization condition.

It is unnecessary for a user to prepare all information used for execution of authentication and authorization. Therefore, an increase in convenience is attained.

### Second Embodiment

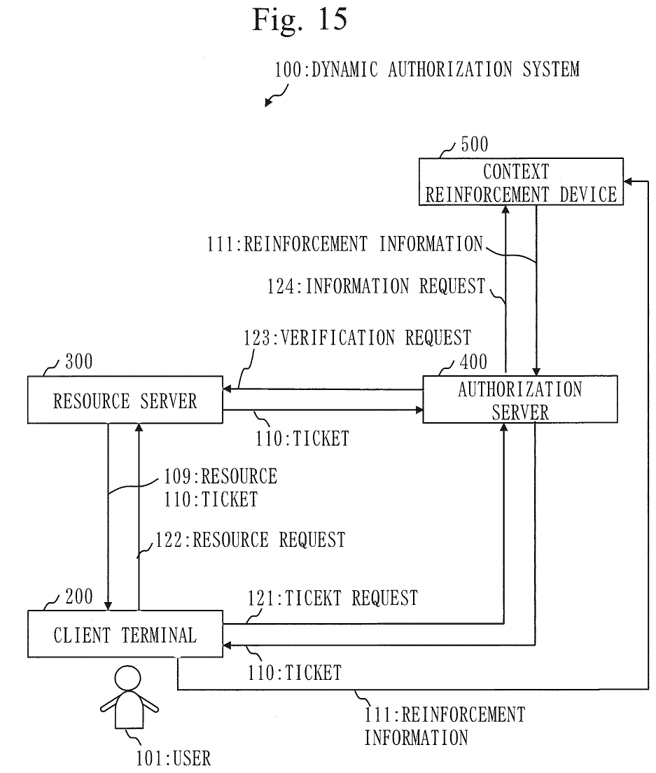

With respect to a form of acquiring the reinforcement information 111 by the context reinforcement device 500 from the client terminal 200, description will be made mainly on different points from First Embodiment, based on FIG. 15 through FIG. 17.

### Description of Configuration

Description will be made on a configuration of the dynamic authorization system 100 based on FIG. 15.

The configuration of the dynamic authorization system 100 is the same as that in First Embodiment.

However, the context reinforcement device 500 acquires the reinforcement information 111 from the client terminal 200.

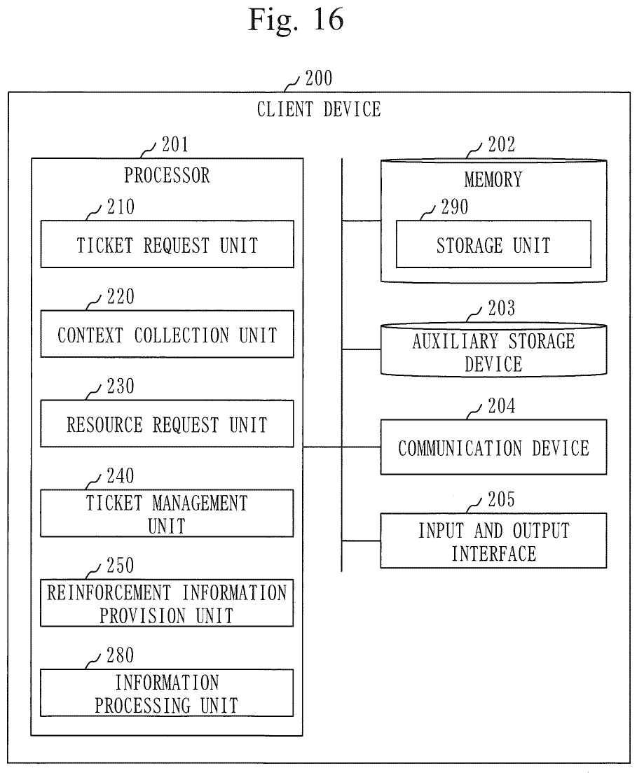

Description will be made on a configuration of the client terminal 200 based on FIG. 16.

The client terminal 200 further includes an element called a reinforcement information provision unit 250.

The client terminal program further causes a computer to function as the reinforcement information provision unit 250.

### Description of Operation

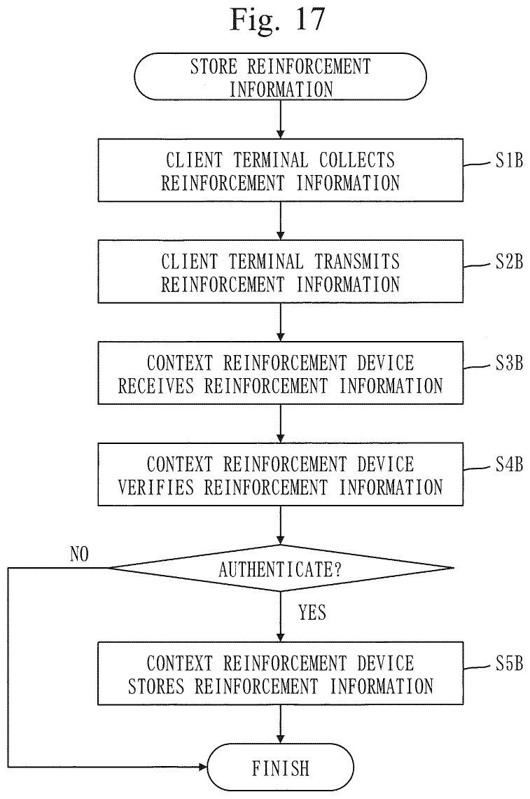

The procedure of reinforcement information storage will be described based on FIG. 17.

The reinforcement information storage is a process to store the reinforcement information 111 in the context reinforcement device 500.

Step S1B and Step S2B are performed by the client terminal 200.

Step S3B through Step S5B are performed by the context reinforcement device 500.

In Step S1B, the reinforcement information provision unit 250 collects the reinforcement information 111 of the client terminal 200. The reinforcement information 111 is various types of information other than the context.

Specifically, the reinforcement information provision unit 250 collects the reinforcement information 111 from an OS or a BIOS using a command. The reinforcement information 111 indicates a configuration of the client terminal 200, a secure boot state, an execution environment (physical or virtual) of the OS, an IP address, a manufacturer or the like.

In order to prevent falsification of the reinforcement information 111, and ensure reliability of the reinforcement information 111, the reinforcement information provision unit 250 may attach an electronic signature to the reinforcement information 111.

In Step S2B, the reinforcement information provision unit 250 transmits the user identifier and the reinforcement information 111 collected to the context reinforcement device 500.

In Step S3B, the reinforcement information acquisition unit 520 receives the user identifier and the reinforcement information 111 from the client terminal 200.

In Step S4B, the reinforcement information acquisition unit 520 verifies the reinforcement information 111 as needed.

The verification method is the same as the method in Step S3543.

When the reinforcement information 111 is authenticated, or authentication of the reinforcement information 111 is unnecessary, the process proceeds to Step S5B.

When the reinforcement information 111 is not authenticated, the process is finished. In this case, the reinforcement information acquisition unit 520 notifies the context reinforcement device 500 that the reinforcement information 111 is invalid. Further, the reinforcement information acquisition unit 520 discards the reinforcement information 111. That is, the reinforcement information 111 is not stored.

In Step S5B, the reinforcement information acquisition unit 520 stores the reinforcement information 111 to be corresponding to the user identifier.

### Feature of Second Embodiment

The reinforcement information acquisition/verification instrument (500) acquires the reinforcement information 111 from the client (200) before authentication and authorization.

### Effect of Second Embodiment

By Second Embodiment, the context reinforcement device 500 is capable of acquiring and storing the reinforcement information 111.

### Third Embodiment

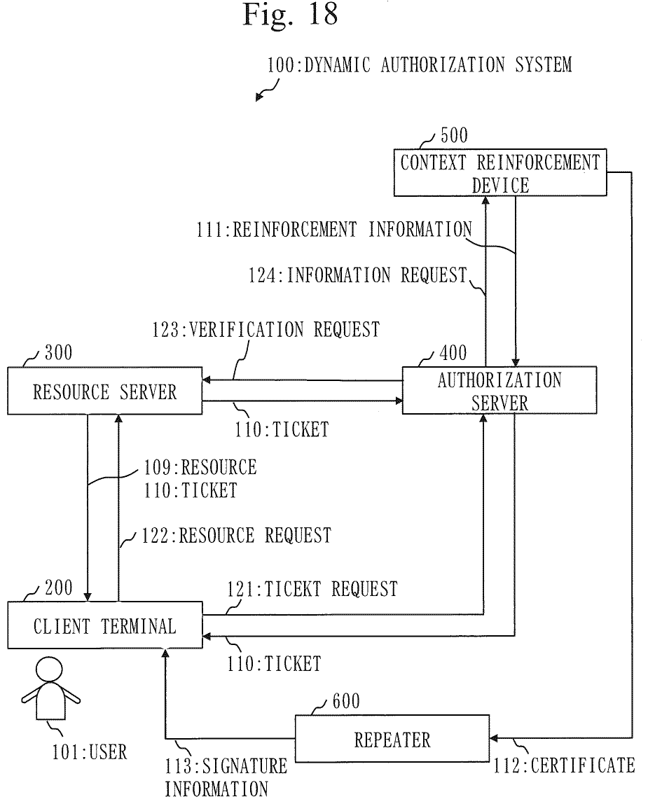

With respect to a form of using information with a signature as a context, description will be made mainly on different points from First Embodiment, based on FIG. 18 through FIG. 24.

### Description of Configuration

Description will be made on a configuration of the dynamic authorization system 100 based on FIG. 18.

The dynamic authorization system 100 further includes a repeater 600.

A specific example of the repeater 600 is a router.

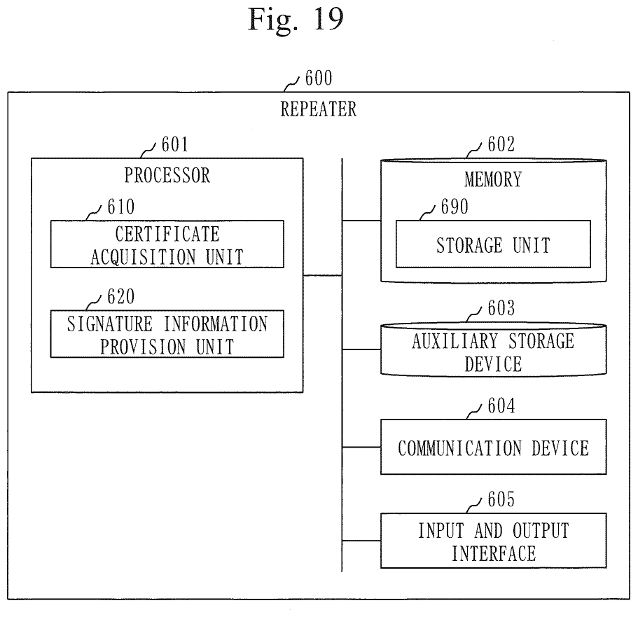

Description will be made on a configuration of the repeater 600 based on FIG. 19.

The repeater 600 is a computer including hardware components such as a processor 601, a memory 602, an auxiliary storage device 603, a communication device 604 and an input and output interface 605. These hardware components are connected with one another via signal lines.

The processor 601 is an IC to perform arithmetic processing, and controls other hardware components. For example, the processor 601 is a CPU.

The memory 602 is a volatile or non-volatile storage device. The memory 602 is also called a main storage device or a main memory. For example, the memory 602 is a RAM. The data stored in the memory 602 is stored in the auxiliary storage device 603 as needed.

The auxiliary storage device 603 is a non-volatile storage device. For example, the auxiliary storage device 603 is a ROM, an HDD, a flash memory or a combination thereof. The data stored in the auxiliary storage device 603 is loaded into the memory 602 as needed.

The communication device 604 is a receiver and a transmitter. For example, the communication device 604 is a communication chip or an NIC. Communication by the repeater 600 is performed using the communication device 604.

The input and output interface 605 is a port to which an input device and an output device are connected.

The repeater 600 includes elements such as a certificate acquisition unit 610 and a signature information provision unit 620. These elements are realized by software.

The auxiliary storage device 603 is stored in a repeater program to cause a computer to function as the certificate acquisition unit 610 and the signature information provision unit 620. The repeater program is loaded into the memory 602, and executed by the processor 601.

The auxiliary storage device 603 further stores an OS. At least a part of the OS is loaded into the memory 602, and executed by the processor 601.

The processor 601 executes the repeater program while executing the OS.

The input and output data of the repeater program is stored in a storage unit 690.

The memory 602 functions as the storage unit 690. However, storage devices such as the auxiliary storage device 603, a register in the processor 601, a cache memory in the processor 601 may function as the storage unit 690 instead of the memory 602 or along with the memory 602.

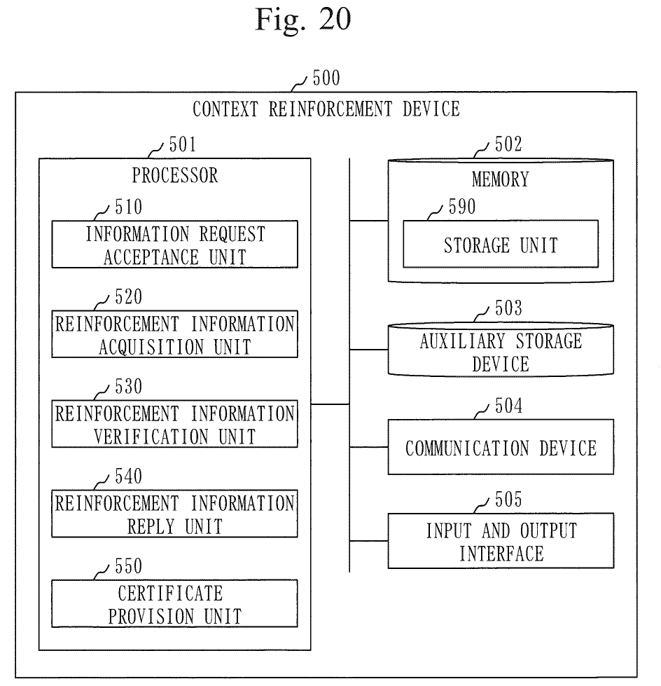

Description will be made on a configuration of the context reinforcement device 500 based on FIG. 20.

The context reinforcement device 500 further includes an element called a certificate provision unit 550.

The context reinforcement program further causes a computer to function as the certificate provision unit 550.

### Description of Operation

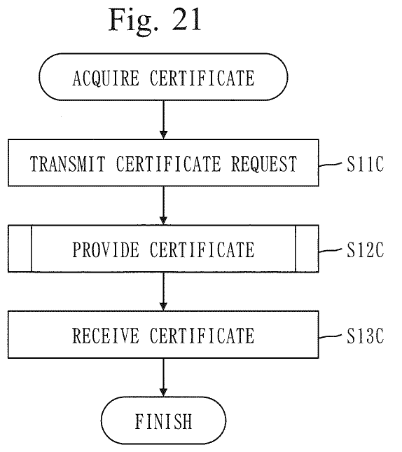

Description will be made on certificate acquisition based on FIG. 21.

Certificate acquisition is a process by the repeater 600 to acquire a certificate 112.

The certificate 112 is an electronic certificate for the repeater 600.

In Step S11C, the certificate acquisition unit 610 generates a certificate request, and transmits the certificate request to the context reinforcement device 500.

The certificate request is data to request the certificate 112.

The certificate request includes a repeater identifier and connection information.

The repeater identifier identifies the repeater 600.

The connection information is information related to the repeater 600. For example, the connection information indicates an SSID, an IP address, an encryption scheme and the like.

In Step S12C, the context reinforcement device 500 provides the certificate 112.

Details of Step S12C will be described later.

In Step S13C, the certificate acquisition unit 610 receives the certificate 112 from the context reinforcement device 500, and stores the certificate 112.

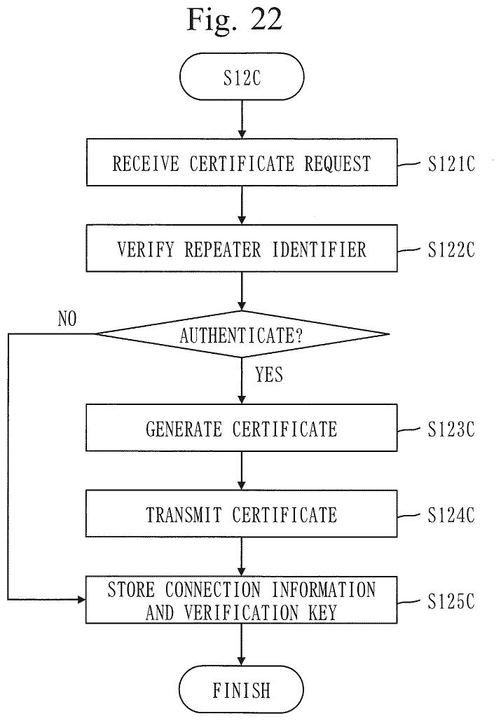

Description will be made on the procedure of Step S12C based on FIG. 22.

In Step S121C, the certificate provision unit 550 receives the certificate request from the repeater 600.

In Step S122C, the certificate provision unit 550 extracts the repeater identifier from the certificate request. The repeater identifier extracted is called a target identifier.

Then, the certificate provision unit 550 verifies the target identifier, and authenticates the repeater 600.

The target identifier is verified as follows.

A repeater list is stored in the storage unit 590 beforehand.

The repeater list indicates an identifier of a reliable repeater.

The certificate provision unit 550 decides whether the target identifier is indicated in the repeater list.

When the target identifier is indicated in the repeater list, the certificate provision unit 550 authenticates the repeater 600.

When the repeater 600 is authenticated, the process proceeds to Step S123C.

When the repeater 600 is not authenticated, the process is finished. In this case, the certificate provision unit 550 notifies the repeater 600 that the certificate 112 cannot be provided.

In Step S123C, the certificate provision unit 550 generates a certificate 112.

The certificate 112 is generated as follows.

First, the certificate provision unit 550 generates a key pair for encryption. The key pair is a pair of a signature key and a verification key.

Then, the certificate provision unit 550 generates an electronic certificate including the signature key. The electronic certificate generated is the certificate 112.

In Step S124C, the certificate provision unit 550 transmits the certificate 112 to the repeater 600.

In Step S125C, the certificate provision unit 550 associates the connection information and the verification key with each other, and stores them as the reinforcement information 111.

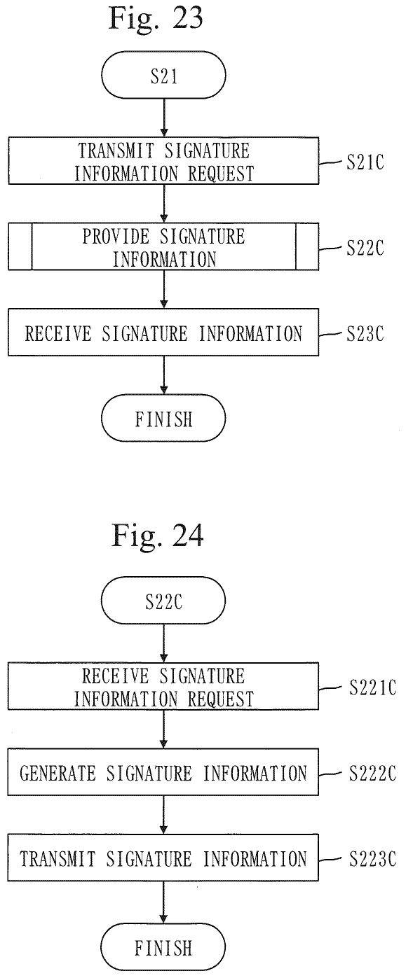

Step S21 will be described based on FIG. 23.

In Step S21, the context collection unit 220 acquires a context as follows.

In Step S21C, the context collection unit 220 generates a signature information request, and transmits the signature information request to the repeater 600.

The signature information request is data to request signature information 113. The signature information 113 is connection information with signature.

In Step S22C, the repeater 600 provides the signature information 113.

Details of Step S22C will be described later.

In Step S23C, the context collection unit 220 receives the signature information 113.

The signature information 113 is a context.

The procedure of Step S22C will be described based on FIG. 24.

In Step S221C, the signature information provision unit 620 receives the signature information request from the client terminal 200.

In Step S222C, the signature information provision unit 620 generates the signature information 113.

Specifically, the signature information provision unit 620 generates a signature for the connection information using the signature key included in the certificate 112. The signature information 113 includes connection information and a signature.

In Step S223C, the signature information provision unit 620 transmits the signature information 113 to the client terminal 200.

As described in Step S125C, the connection information and the verification key are stored in the context reinforcement device 500 as the reinforcement information 111. The connection information and the verification key are used as follows.

In Step S3541, the information request acceptance unit 510 receives an information request from the authorization server 400. The information request includes the signature information 113 being the context.

In Step S3542, the reinforcement information acquisition unit 520 acquires a verification key that is associated with the same connection information as the connection information indicated in the signature information 113.

In Step S3543, the reinforcement information verification unit 530 verifies the signature included in the signature information 113, using the verification key acquired.

### Feature of Third Embodiment

The reinforcement information acquisition/verification instrument (500) stores the reinforcement information (connection information and verification key) from a communication repeater before authentication and authorization.

### Effect of Third Embodiment

According to Third Embodiment, it is possible to use the signature information 113 as the context.

### Supplement to Third Embodiment

Third Embodiment may be performed in combination with Second Embodiment. That is, in Third Embodiment, at least any reinforcement information 111 may be acquired from the client terminal 200.

### Fourth Embodiment

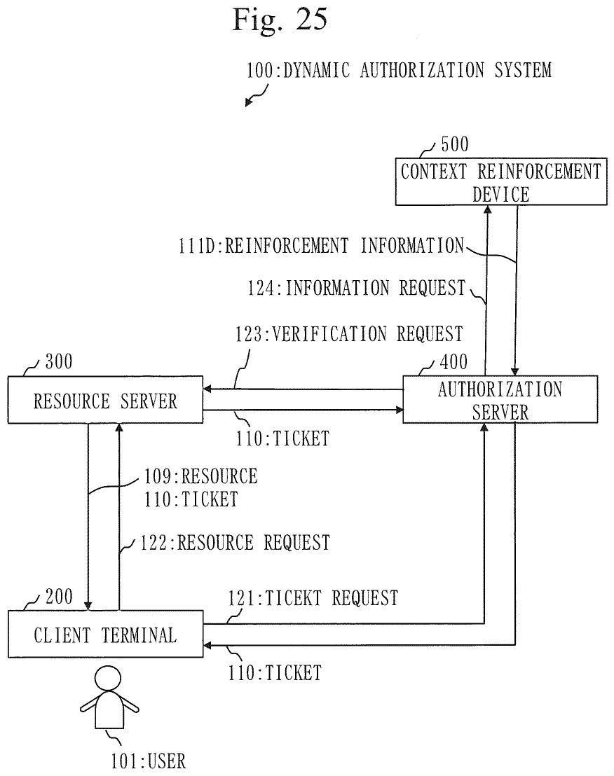

With respect to a form of attaching a score to the reinforcement information 111, description will be mainly made on different points from First Embodiment, based on FIG. 25.

### Description of Configuration

Description will be made on a configuration of the dynamic authorization system 100 based on FIG. 25.

The configuration of the dynamic authorization system 100 is the same as that in First Embodiment.

However, reinforcement information 111D instead of the reinforcement information 111 is provided to the authorization server 400 from the context reinforcement device 500.

The reinforcement information 111D is reinforcement information 111 to which a score is attached.

The score indicates a degree of reliability of the reinforcement information 111.

### Description of Operation

The procedure of a dynamic authorization method is the same as that in First Embodiment.

However, in the following steps, the score of the reinforcement information 111 is considered.

In Step S3544, the reinforcement information reply unit 540 transmits the reinforcement information 111D to the authorization server 400.

In this case, the reinforcement information reply unit 540 determines the score of the reinforcement information 111 in accordance with whether the reinforcement information 111 has been verified, and the type of verification, and attaches the score determined to the reinforcement information 111.

The score is determined as follows.

A score list is stored in the storage unit 590 beforehand.

The score list indicates the score to be corresponding to whether the reinforcement information 111 has been verified, and the type of verification.

For example, the score in a case where an electronic signature attached to the reinforcement information 111 is verified is “3”. The score in a case where a serial number indicated in the reinforcement information 111 is verified is “2”. The serial number is checked by communication with a server of a manufacturer. Further, the score in a case where verification is not performed is “1”.

The reinforcement information reply unit 540 acquires the score associated with whether the reinforcement information 111 has been verified, and the type of verification, from the score list. The score acquired is a score determined.

In Step S356, the ticket verification unit 420 verifies the scope based on the context and the reinforcement information 111D.

Specifically, the ticket verification unit 420 decides whether the context, the reinforcement information 111 and the score of the reinforcement information 111 meat an authorization condition.

The authorization condition may include a condition of the score of the reinforcement information 111.

In the case where the condition of the score is included in the authorization condition, even when the context and the reinforcement information 111 meat the condition, the authorization condition is not met unless the score meets the condition.

For example, when the condition of “score≥3” is included the authorization condition, the authorization condition is not met unless the score is equal to or larger than 3.

### Feature of Fourth Embodiment

The reinforcement information acquisition/verification instrument (500) acquires reinforcement information (111), and attaches a reliability score to the reinforcement information in consideration of reliability of the acquisition source, i.e., the information source, and security of the acquisition method.

### Effect of Fourth Embodiment

According to Fourth Embodiment, it is possible to perform authorization in consideration of reliability of the reinforcement information 111.

### Supplement of Fourth Embodiment

Fourth Embodiment may be performed in combination with Second Embodiment. That is, in Fourth Embodiment, at least any reinforcement information 111 may be acquired from the client terminal 200.

Fourth Embodiment may be performed in combination with Third Embodiment. That is, in Fourth Embodiment, the signature information 113 may be used as the context.

### Fifth Embodiment

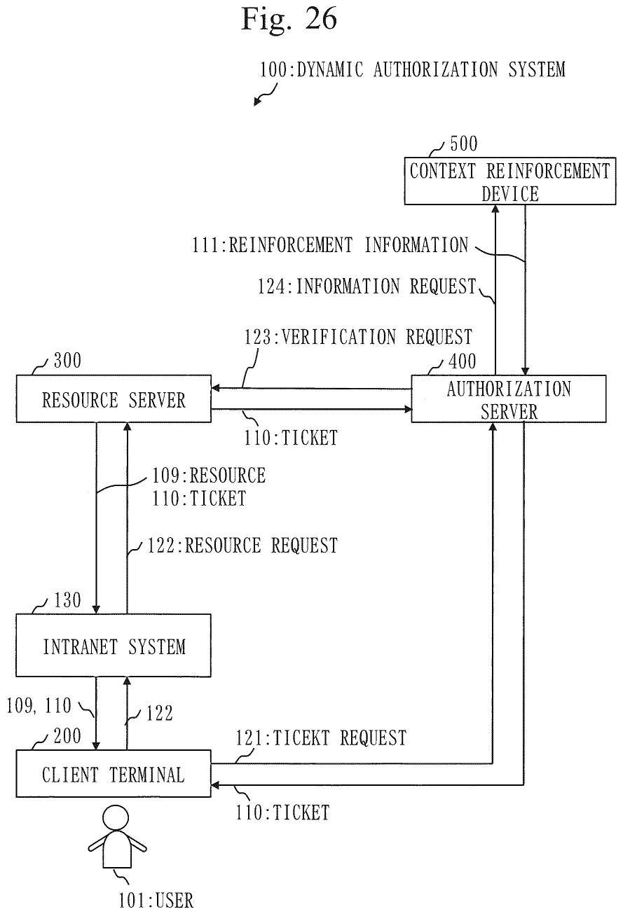

With respect to a form of requesting a resource by the client terminal 200 via an intranet system 130, description will be mainly made on different points from First Embodiment, based on FIG. 26 through FIG. 30.

### Description of Configuration

Description will be made on a configuration of the dynamic authorization system 100 based on FIG. 26.

The dynamic authorization system 100 further includes an intranet system 130.

The intranet system 130 is a computer system to configure an intranet.

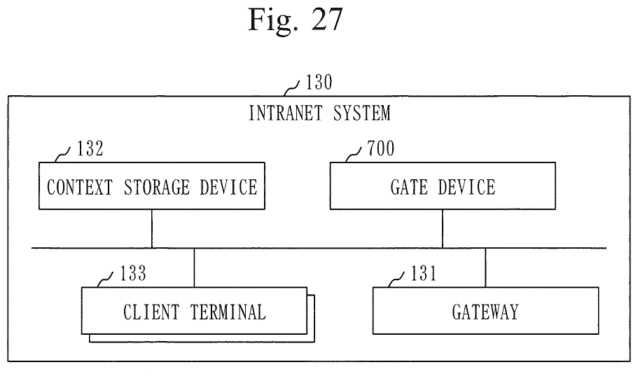

Description will be made on a configuration of the intranet system 130 based on FIG. 27.

The intranet system 130 includes a gateway 131, a context storage device 132, one or more client terminals 133 and a gate device 700.

The gateway 131 is a communication apparatus to function as a gateway of the intranet system 130.

The context storage device 132 is a computer to store information of the intranet system 130 as a context, and includes a storage device to store the context.

For example, an access policy and an access history are stored as contexts. The access policy is a policy determined so as to access the resource server 300 in a company to operate the intranet system 130. An access history is a history of access from each client terminal 133 to the resource server 300. In addition to these, an IP address close to the resource server 300 and the like are stored as the contexts.

The client terminal 133 is a client terminal installed in the intranet system 130.

The gate device 700 controls access to the resource server 300.

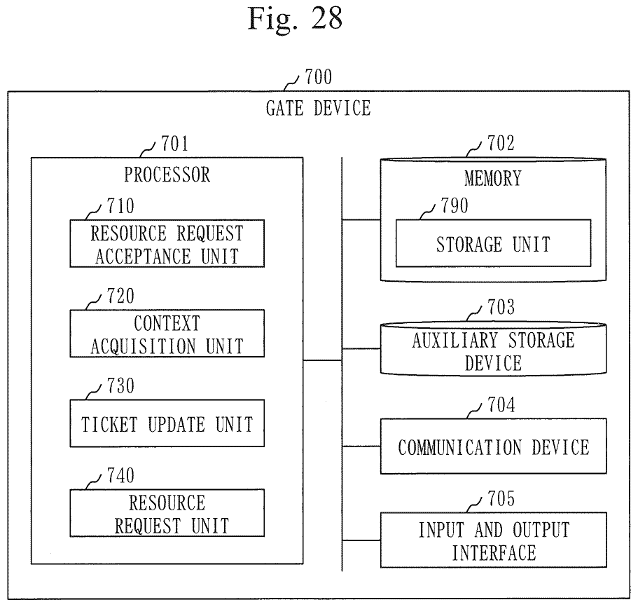

Description will be made on a configuration of the gate device 700 based on FIG. 28.

The gate device 700 is a computer to include hardware components such as a processor 701, a memory 702, an auxiliary storage device 703, a communication device 704 and an input and output interface 705. These hardware components are connected with one another via signal lines.

The processor 701 is an IC to perform arithmetic processing, and controls other hardware components. For example, the processor 701 is a CPU.

The memory 702 is a volatile or non-volatile storage device. The memory 702 is also called a main storage device or a main memory. For example, the memory 702 is a RAM. The data stored in the memory 702 is stored in the auxiliary storage device as needed.

The auxiliary storage device 703 is a non-volatile storage device. For example, the auxiliary storage device 703 is a ROM, an HDD, a flash memory or a combination thereof. The data stored in the auxiliary storage device 703 is loaded into the memory 702 as needed.

The communication device 704 is a receiver and a transmitter. For example, the communication device 704 is a communication chip or an NIC. The communication by the gate device 700 is performed using the communication device 704.

The input and output interface 705 is a port to which an input device and an output device are connected.

The gate device 700 includes elements such as a resource request acceptance unit 710, a context acquisition unit 720, a ticket update unit 730, a resource request unit 740 and a resource provision unit 750. These elements are realized by software.

The auxiliary storage device 703 stores a gate device program to cause a computer to function as the resource request acceptance unit 710, the context acquisition unit 720, the ticket update unit 730, the resource request unit 740 and the resource provision unit 750. The gate device program is loaded into the memory 702, and executed by the processor 701.

The auxiliary storage device 703 further stores an OS. At least a part of the OS is loaded into the memory 702, and executed by the processor 701.

The processor 701 executes the gate device program while executing the OS.

The input and output data of the gate device program is stored in the storage unit 790.

The memory 702 functions as a storage unit 790. However, storage devices such as the auxiliary storage device 703, a register in the processor 701, a cache memory in the processor 701 and the like may function as the storage unit 790 instead of the memory 702, or along with the memory 702.

### Description of Operation

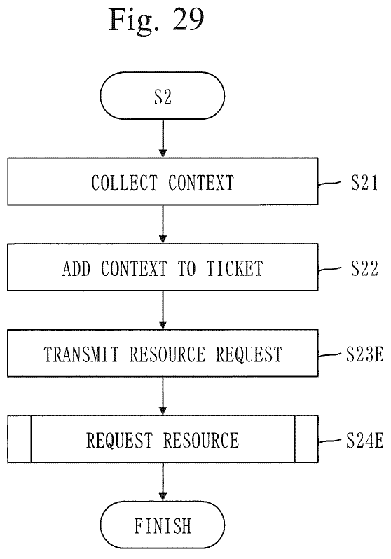

Description will be made on Step S2 based on FIG. 29.

Step S21 and Step S22 are as described in First Embodiment.

In Step S23E, the resource request unit 230 generates a resource request 122, and transmits the resource request 122 to the gate device 700 via the gateway 131.

In Step S24E, the gate device 700 requests the resource 109 to the authorization server 400.

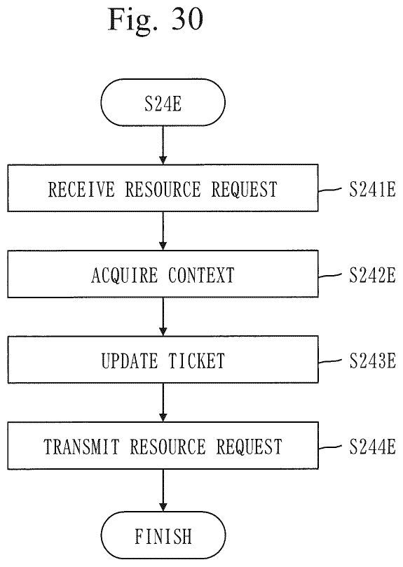

Description will be made on a procedure of Step S24E based on FIG. 30.

In Step S241E, the resource request acceptance unit 710 receives the resource request 122.

In Step S242E, the context acquisition unit 720 acquires a context from the context storage device 132.

In Step S243E, the ticket update unit 730 updates the ticket 110 included in the resource request 122.

Specifically, the ticket update unit 730 adds the context acquired to the ticket 110.

In Step S244E, the resource request unit 740 transmits the resource request 122 after the ticket 110 has been updated to the resource server 300.

The context acquired from the context storage device 132 is used for verification of the ticket 110 in Step S356.

It is possible for the scope indicated in the ticket 110 to include an authorization condition having the context stored in the context storage device 132 as a condition element.

### Feature of Fifth Embodiment

The dynamic authorization system (100) includes an authentication gate (700). The authentication gate performs proxy access. Further, the authentication gate handles context information such as a history related to a user of the intranet and the like as reinforcement information. Then, the authentication gate reinforces the context information and performs authorization by cooperating with the reinforcement information acquisition/verification instrument (500) via the authorization server (400).

### Effect of Fifth Embodiment

According to Fifth Embodiment, it is possible to use the information of the intranet as the context, and to request the resource via the intranet.

### Supplement to Fifth Embodiment

The client terminal 200 may be a client terminal 133 installed in the intranet system 130.

Fifth embodiment may be performed in combination with Second Embodiment. That is, in Fifth Embodiment, at least any reinforcement information 111 may be acquired from the client terminal 200.

Fifth Embodiment may be performed in combination with Third Embodiment. That is, in Fifth Embodiment, the signature information 113 may be used as the context.

Fifth Embodiment may be performed in combination with Fourth Embodiment. That is, in Fifth Embodiment, the score may be attached to the reinforcement information 111.

### Supplement to Embodiments

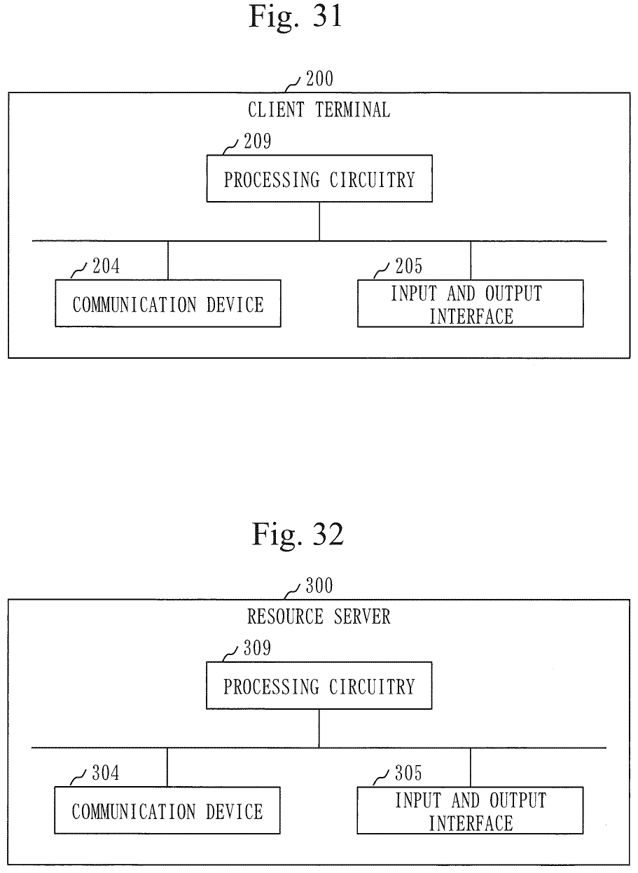

Description will be made on a hardware configuration of the client terminal 200 based on FIG. 31.

The client terminal 200 includes processing circuitry 209.

The processing circuitry 209 is a hardware component to realize the ticket request unit 210, the context collection unit 220, the resource request unit 230, the ticket management unit 240 and the reinforcement information provision unit 250.

The processing circuitry 209 may be a dedicated hardware component, or may be the processor 201 to execute the programs stored in the memory 202.

When the processing circuitry 209 is the dedicated hardware component, the processing circuitry 209 is, for example, a single circuit, a composite circuit, a programmed processor, a parallel-programmed processor, an ASIC, an FPGA, or a combination thereof.

ASIC is an abbreviation for “Application Specific Integrated Circuit”.

FPGA is an abbreviation for “Field Programmable Gate Array”.

The client terminal 200 may include a plurality of processing circuits to be substitutes for the processing circuitry 209.

In the processing circuitry 209, a part of the functions may be realized by a dedicated hardware component, and the remaining functions may be realized by software or firmware.

As described, the functions of the client terminal 200 may be realized by hardware, software, firmware, or a combination thereof.

Description will be made on a hardware configuration of the resource server 300 based on FIG. 32.

The resource server 300 includes processing circuitry 309.

The processing circuitry 309 is a hardware component to realize the resource request acceptance unit 310, the ticket confirmation unit 320, the verification request unit 330, the ticket return unit 340 and the resource provision unit 350.

The processing circuitry 309 may be a dedicated hardware component, or may be the processor 301 to execute the programs stored in the memory 302.

When the processing circuitry 309 is the dedicated hardware component, the processing circuitry 309 is, for example, a single circuit, a composite circuit, a programmed processor, a parallel-programmed processor, an ASIC, an FPGA, or a combination thereof.

The resource server 300 may include a plurality of processing circuits to be substitutes for the processing circuitry 309.

In the processing circuitry 309, a part of the functions may be realized by a dedicated hardware component, and the remaining functions may be realized by software or firmware.

As described, the functions of the resource server 300 may be realized by hardware, software, firmware, or a combination thereof.

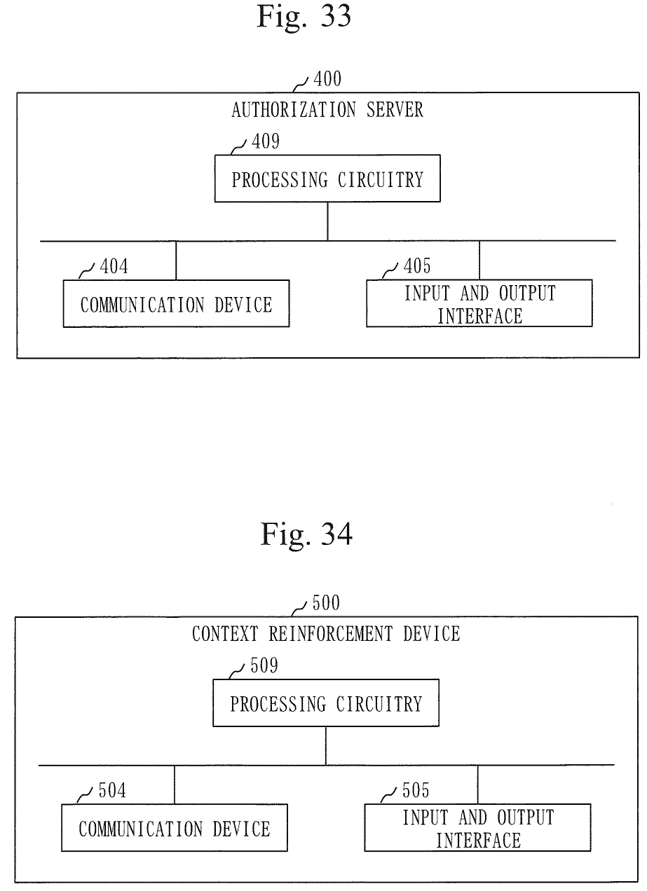

Description will be made on a hardware configuration of the authorization server 400 based on FIG. 33.

The authorization server 400 includes processing circuitry 409.

The processing circuitry 409 is a hardware component to realize the ticket issue unit 410, the ticket verification unit 420 and the reinforcement information request unit 430.

The processing circuitry 409 may be a dedicated hardware component, or may be the processor 401 to execute programs stored in the memory 402.

When the processing circuitry 409 is the dedicated hardware, the processing circuitry 409 is, for example, a single circuit, a composite circuit, a programmed processor, a parallel-programmed processor, an ASIC, an FPGA, or a combination thereof.

The authorization server 400 may include a plurality of processing circuits to be substitutes for the processing circuitry 409.

In the processing circuitry 409, a part of the functions may be realized by a dedicated hardware component, and the remaining functions may be realized by software or firmware.

As described, the functions of the authorization server 400 may be realized by hardware, software, firmware, or a combination thereof.

Description will be made on a hardware configuration of the context reinforcement device 500 based on FIG. 34.

The context reinforcement device 500 includes processing circuitry 509.

The processing circuitry 509 is a hardware component to realize the information request acceptance unit 510, the reinforcement information acquisition unit 520, the reinforcement information verification unit 530, the reinforcement information reply unit 540 and the certificate provision unit 550.

The processing circuitry 509 may be a dedicated hardware component, or may be the processor 501 to execute the programs stored in the memory 502.

When the processing circuitry 509 is the dedicated hardware component, the processing circuitry 509 is, for example, a single circuit, a composite circuit, a programmed processor, a parallel-programmed processor, an ASIC, an FPGA, or a combination thereof.

The context reinforcement device 500 may include a plurality of processing circuits to be substitutes for the processing circuitry 509.

In the processing circuitry 509, a part of the functions may be realized by a dedicated hardware component, and the remaining functions may be realized by software or firmware.

As described, the functions of the context reinforcement device 500 may be realized by hardware, software, firmware, or a combination thereof.

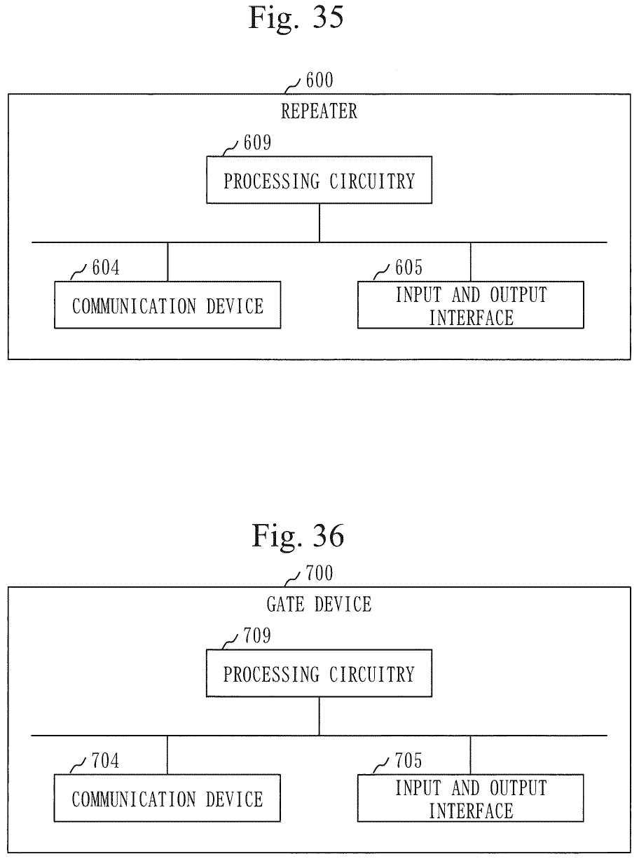

Description will be made on a hardware configuration of the repeater 600 based on FIG. 35.

The repeater 600 includes processing circuitry 609.

The processing circuitry 609 is a hardware component to realize the certificate acquisition unit 610 and the signature information provision unit 620.

The processing circuitry 609 may be a dedicated hardware component, or may be the processor 601 to execute the programs stored in the memory 602.

When the processing circuitry 609 is the dedicated hardware component, the processing circuitry 609 is, for example, a single circuit, a composite circuit, a programmed processor, a parallel-programmed processor, an ASIC, an FPGA, or a combination thereof.

The repeater 600 may include a plurality of processing circuits to be substitutes for the processing circuitry 609.

In the processing circuitry 609, a part of the functions may be realized by a dedicated hardware component, and the remaining functions may be realized by software or firmware.

As described, the functions of the repeater 600 may be realized by hardware, software, firmware, or a combination thereof.

Description will be made on a hardware configuration of the gate device 700 based on FIG. 36.

The gate device 700 includes processing circuitry 709.

The processing circuitry 709 is a hardware component to realize the resource request acceptance unit 710, the context acquisition unit 720, the ticket update unit 730, the resource request unit 740 and the resource provision unit 750.

The processing circuitry 709 may be a dedicated hardware component, or may be the processor 701 to execute the programs stored in the memory 702.

When the processing circuitry 709 is the dedicated hardware component, the processing circuitry 709 is, for example, a single circuit, a composite circuit, a programmed processor, a parallel-programmed processor, an ASIC, an FPGA, or a combination thereof.

The gate device 700 may include a plurality of processing circuits to be substitutes for the processing circuitry 709.

In the processing circuitry 709, a part of the functions may be realized by a dedicated hardware component, and the remaining functions may be realized by software or firmware.

As described, the functions of the gate device 700 may be realized by hardware, software, firmware, or a combination thereof.

Each embodiment is a preferable example, and is not intended for limiting the technical scope of the present disclosure. Each embodiment may be partially implemented, or may be implemented in combination with another embodiment. The procedures described by using the flowcharts and the like may be changed appropriately.

“Unit” of each element in the dynamic authorization system 100 may be replaced with “process”, “step”, “circuit” or “circuitry”.

### REFERENCE SIGNS LIST

100: dynamic authorization system; 101: user; 109: resource; 110: ticket; 111: reinforcement information; 112: certificate; 113: signature information; 121: ticket request; 122: resource request; 123: verification request; 124: information request; 130: intranet system; 131: gateway; 132: context storage device; 133: client terminal; 200: client terminal; 201: processor; 202: memory; 203: auxiliary storage device; 204: communication device; 205: input and output interface; 209: processing circuitry; 210: ticket request unit; 220: context collection unit; 230: resource request unit; 240: ticket management unit; 250: reinforcement information provision unit; 280: information processing unit; 290: storage unit; 300: resource server; 301: processor; 302: memory; 303: auxiliary storage device; 304: communication device; 305: input and output interface; 309: processing circuitry; 310: resource request acceptance unit; 320: ticket confirmation unit; 330: verification request unit; 340: ticket return unit; 350: resource provision unit; 390: storage unit; 400: authorization server; 401: processor; 402: memory; 403: auxiliary storage device; 404: communication device; 405: input and output interface; 409: processing circuitry; 410: ticket issue unit; 420: ticket verification unit; 430: reinforcement information request unit; 490: storage unit; 500: context reinforcement device; 501: processor; 502: memory; 503: auxiliary storage device; 504: communication device; 505: input and output interface; 509: processing circuitry; 510: information request acceptance unit; 520: reinforcement information acquisition unit; 530: reinforcement information verification unit; 540: reinforcement information reply unit; 550: certificate provision unit; 590: storage unit; 600: repeater; 601: processor; 602: memory; 603: auxiliary storage device; 604: communication device; 605: input and output interface; 609: processing circuitry; 610: certificate acquisition unit; 620: signature information provision unit; 690: storage unit; 700: gate device; 701: processor; 702: memory; 703: auxiliary storage device; 704: communication device; 705: input and output interface; 709: processing circuitry; 710: resource request acceptance unit; 720: context acquisition unit; 730: ticket update unit; 740: resource request unit; 750: resource provision unit; 790: storage unit

1. A dynamic authorization system comprising a client terminal, an authorization server and a context reinforcement device, wherein
the client terminal acquires a ticket including a scope to indicate an authorization condition, collects a context to indicate a state of the client terminal, sets the context in the ticket, and transmits the ticket,
the authorization server receives the ticket, determines a condition element other than the context among one or more condition elements indicated in the authorization condition as reinforcement information, and requests the reinforcement information determined to the context reinforcement device,
the context reinforcement device transmits the reinforcement information requested to the authorization server, and
the authorization server receives the reinforcement information, and verifies the scope based on the context and the reinforcement information.

2. The dynamic authorization system as defined in claim 1, wherein
the client terminal collects a variety of information other than the context as the reinforcement information, and transmits the reinforcement information collected to the context reinforcement device, and
the context reinforcement device receives the reinforcement information collected, stores the reinforcement information received, and transmits the reinforcement information requested among the reinforcement information stored, to the authorization server, when a request is made from the authorization server.

3. The dynamic authorization system as defined in claim 1,
the dynamic authorization system further includes a repeater,
wherein
the repeater generates a signature with respect to connection information being information related to the repeater using a signature key,
the client terminal receives the connection information with the signature from the repeater, and sets the connection information with the signature in the ticket as one of the context, and
the context reinforcement device stores a verification key corresponding to the signature key, verifies the scope, and verifies the signature using the verification key.

4. The dynamic authorization system as defined in claim 2,
the dynamic authorization system further includes a repeater,
wherein
the repeater generates a signature with respect to connection information being information related to the repeater using a signature key,
the client terminal receives the connection information with the signature from the repeater, and sets the connection information with the signature in the ticket as one of the context, and
the context reinforcement device stores a verification key corresponding to the signature key, verifies the scope, and verifies the signature using the verification key.

5. The dynamic authorization system as defined in claim 1, wherein
the context reinforcement device acquires the reinforcement information, verifies the reinforcement information acquired when verification of the reinforcement information acquired is possible, determines a score of the reinforcement information acquired in accordance with whether the reinforcement information acquired has been verified, and a type of the verification, stores the reinforcement information acquired after being attached the score determined, and transmits the reinforcement information requested among the reinforcement information stored to the authorization server together with a score of the reinforcement information requested when a request is made from the authorization server, and wherein
the authorization server receives the reinforcement information and the score, and verifies the scope based on the context, the reinforcement information and the score.

6. The dynamic authorization system as defined in claim 2, wherein
the context reinforcement device acquires the reinforcement information, verifies the reinforcement information acquired when verification of the reinforcement information acquired is possible, determines a score of the reinforcement information acquired in accordance with whether the reinforcement information acquired has been verified, and a type of the verification, stores the reinforcement information acquired after being attached the score determined, and transmits the reinforcement information requested among the reinforcement information stored to the authorization server together with a score of the reinforcement information requested when a request is made from the authorization server, and wherein
the authorization server receives the reinforcement information and the score, and verifies the scope based on the context, the reinforcement information and the score.

7. The dynamic authorization system as defined in claim 3, wherein
the context reinforcement device acquires the reinforcement information, verifies the reinforcement information acquired when verification of the reinforcement information acquired is possible, determines a score of the reinforcement information acquired in accordance with whether the reinforcement information acquired has been verified, and a type of the verification, stores the reinforcement information acquired after being attached the score determined, and transmits the reinforcement information requested among the reinforcement information stored to the authorization server together with a score of the reinforcement information requested when a request is made from the authorization server, and wherein
the authorization server receives the reinforcement information and the score, and verifies the scope based on the context, the reinforcement information and the score.

8. The dynamic authorization system as defined in claim 4, wherein
the context reinforcement device acquires the reinforcement information, verifies the reinforcement information acquired when verification of the reinforcement information acquired is possible, determines a score of the reinforcement information acquired in accordance with whether the reinforcement information acquired has been verified, and a type of the verification, stores the reinforcement information acquired after being attached the score determined, and transmits the reinforcement information requested among the reinforcement information stored to the authorization server together with a score of the reinforcement information requested when a request is made from the authorization server, and wherein
the authorization server receives the reinforcement information and the score, and verifies the scope based on the context, the reinforcement information and the score.

9. The dynamic authorization system as defined in claim 1, further comprising an intranet system, wherein
the intranet system includes a gate device, and wherein
the gate device receives the ticket from the client terminal, acquires information of the intranet system, adds the information acquired as the context to the ticket, and transmits the ticket to the authorization server.

10. The dynamic authorization system as defined in claim 2, further comprising an intranet system, wherein
the intranet system includes a gate device, and wherein
the gate device receives the ticket from the client terminal, acquires information of the intranet system, adds the information acquired as the context to the ticket, and transmits the ticket to the authorization server.

11. The dynamic authorization system as defined in claim 3, further comprising an intranet system, wherein
the intranet system includes a gate device, and wherein
the gate device receives the ticket from the client terminal, acquires information of the intranet system, adds the information acquired as the context to the ticket, and transmits the ticket to the authorization server.

12. The dynamic authorization system as defined in claim 4, further comprising an intranet system, wherein
the intranet system includes a gate device, and wherein
the gate device receives the ticket from the client terminal, acquires information of the intranet system, adds the information acquired as the context to the ticket, and transmits the ticket to the authorization server.

13. The dynamic authorization system as defined in claim 5, further comprising an intranet system, wherein
the intranet system includes a gate device, and wherein
the gate device receives the ticket from the client terminal, acquires information of the intranet system, adds the information acquired as the context to the ticket, and transmits the ticket to the authorization server.

14. The dynamic authorization system as defined in claim 6, further comprising an intranet system, wherein
the intranet system includes a gate device, and wherein
the gate device receives the ticket from the client terminal, acquires information of the intranet system, adds the information acquired as the context to the ticket, and transmits the ticket to the authorization server.

15. The dynamic authorization system as defined in claim 7, further comprising an intranet system, wherein
the intranet system includes a gate device, and wherein
the gate device receives the ticket from the client terminal, acquires information of the intranet system, adds the information acquired as the context to the ticket, and transmits the ticket to the authorization server.

16. The dynamic authorization system as defined in claim 8, further comprising an intranet system, wherein
the intranet system includes a gate device, and wherein
the gate device receives the ticket from the client terminal, acquires information of the intranet system, adds the information acquired as the context to the ticket, and transmits the ticket to the authorization server.

17. A dynamic authorization method, wherein
by a client terminal, acquiring a ticket including a scope to indicate an authorization condition, collecting a context to indicate a state of the client terminal, setting the context in the ticket, and transmitting the ticket,
by an authorization server, receiving the ticket, determining a condition element other than the context among one or more condition elements indicated in the authorization condition as reinforcement information, and requesting the reinforcement information determined,
by a context reinforcement device, transmitting the reinforcement information requested to the authorization server, and
by the authorization server, receiving the reinforcement information, and verifying the scope based on the context and the reinforcement information.
